(19) United States
(12) Patent Application Publication
(10) Pub. No.: US 2025/0245354 A1
(43) Pub. Date: Jul. 31, 2025

(54) STORAGE DEVICE AND ELECTRONIC SYSTEM INCLUDING THE SAME

(71) Applicant: Samsung Electronics Co., Ltd., Suwon-si (KR)

(72) Inventors: Seung-Ho LEE, Suwon-si (KR); Yun-Ho YOUM, Suwon-si (KR); Myung-Sik CHOI, Suwon-si (KR)

(73) Assignee: Samsung Electronics Co., Ltd., Suwon-si (KR)

(21) Appl. No.: 18/769,882

(22) Filed: Jul. 11, 2024

(30) Foreign Application Priority Data
Jan. 26, 2024 (KR) 10-2024-0012371

(51) Int. Cl. G06F 21/60; G06F 21/64

(52) U.S. Cl. CPC G06F 21/602; G06F 21/64

(57) ABSTRACT

An electronic system comprising a storage device configured to generate a device public key and a device private key based on a device CDI generated from a device DICE, generate a host certificate including a first device signature generated by signing a host public key with the device private key in response to receiving a request of generating the host certificate including the host public key, and send a request of generating a device certificate including the host certificate and the device public key; and a host device configured to generate the host public key and a host private key based on a host CDI generated by a host DICE, generate the device certificate including a first host signature generated by signing the device public key with the host private key in response to the request of generating the device certificate, and send the device certificate to the storage device.

### CROSS-REFERENCE TO RELATED APPLICATION

This application claims priority to and the benefit, under 35 U.S.C. § 119, of Korean Patent Application No. 10-2024-0012371 filed in the Korean Intellectual Property Office on Jan. 26, 2024, the entire contents of which are incorporated herein by reference.

### BACKGROUND

The present inventive concepts relate to storage devices and electronic systems including the same.

A storage device stores data. The storage device may be operated according to control by a host device. The storage device may communicate with the host device by using a pair of keys, such as a public key and a private key. The private key may be used in data encryption, and the public key may be used in data decryption. The storage device and the host device may verify reliability of the host device and the storage device by using the public key and the private key.

### SUMMARY

The present inventive concepts provide a storage device for verifying reliability of a host device, and an electronic system including the same.

Some example embodiments of the present inventive concepts provide an electronic system including: a storage device configured to generate a device public key and a device private key based on a device compound device identifier (CDI) generated from a device DICE (Device Identifier Composition Engine), generate a host certificate including a first device signature generated by signing a host public key with the device private key in response to receiving a request of generating the host certificate including the host public key, and send a request of generating a device certificate including the host certificate and the device public key; and a host device configured to generate the host public key and a host private key based on a host CDI generated by a host DICE, generate the device certificate including a first host signature generated by signing the device public key with the host private key in response to the request of generating the device certificate, and send the device certificate to the storage device.

Some example embodiments of the present inventive concepts provide a storage device including: a nonvolatile memory device configured to storing data; and a storage controller configured to receive a request of accessing data from a host processor executing an application of a host device, the request requesting data, send a request of attesting the application to a host attestation module of the host device, the request of attesting the application requesting attestation of the application, and send the data to the host processor based on a result of verifying application attestation data received from the host attestation module.

Some example embodiments of the present inventive concepts provide an electronic system including: a host processor; a host attestation module; and a storage device, the host processor configured to execute an application, generate an application public key and an application private key based on an application ID, and send a request of accessing the storage device; the host attestation module configured to generate a host public key and a host private key based on a host CDI (Compound Device Identifier), generate an application certificate by using the host private key, and send a request of registering the application based on a result of verifying the application certificate in response to the request of accessing the storage device; and the storage device configured to generate a device public key and a device private key based on a device CDI, generate a host certificate by using the device private key, and register information of the application based on a result of verifying the host certificate and the application certificate in response to the request of registering the application.

### BRIEF DESCRIPTION OF THE DRAWINGS

FIG. 1 shows an electronic system including a storage device and a host device according to some example embodiments.

FIG. 2 shows an electronic system for generating a public key and a private key according to some example embodiments.

FIG. 3 shows an electronic system for generating a host certificate and a device certificate according to some example embodiments.

FIG. 4 shows a host certificate and a device certificate according to some example embodiments.

FIG. 5 shows an electronic system for generating an application certificate according to some example embodiments.

FIG. 6 shows an application certificate according to some example embodiments.

FIG. 7 shows an electronic system for verifying an application executed by a host processor according to some example embodiments.

FIG. 8 shows an electronic system for registering information on an application based on a result of verifying an application according to some example embodiments.

FIG. 9 shows an electronic system for requesting attestation of an application according to some example embodiments.

FIG. 10 shows an electronic system for generating a shared key based on a result of verifying application attestation data according to some example embodiments.

FIG. 11 shows an electronic system for generating a host certificate and a device certificate according to some example embodiments.

FIG. 12 shows an electronic system for verifying an application according to some example embodiments.

FIG. 13 shows a flowchart on an electronic system for requesting attestation of an application according to some example embodiments.

FIG. 14 shows a configuration of a storage controller according to some example embodiments.

FIG. 15 shows a configuration of a nonvolatile memory device according to some example embodiments.

### DETAILED DESCRIPTION

In the following detailed description, only certain example embodiments of the present inventive concepts have been shown and described, simply by way of illustration. As those skilled in the art would realize, the described example embodiments may be modified in various different ways, all without departing from the spirit or scope of the present inventive concepts.

Parts that are irrelevant to the description will be omitted to clearly describe the example embodiments, and the same elements will be designated by the same reference numerals throughout the specification.

Unless explicitly described to the contrary, the word “comprise” and variations such as “comprises” or “comprising” will be understood to imply the inclusion of stated elements but not the exclusion of any other elements.

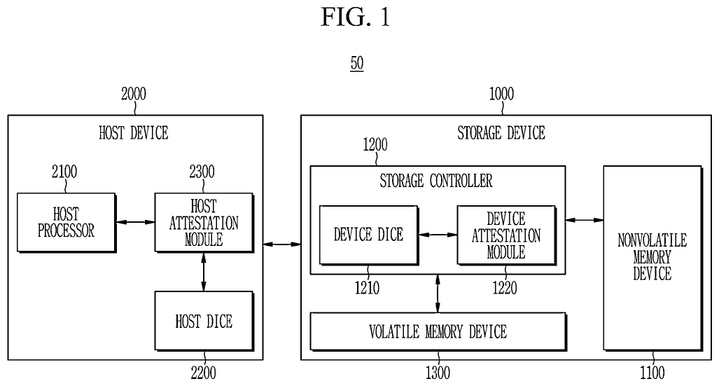

FIG. 1 shows an electronic system including a storage device and a host device according to some example embodiments.

Referring to FIG. 1, the electronic system 50 may include a storage device 1000 and a host device 2000.

The host device 2000 may include a host processor 2100, a host device identifier composition engine (DICE) 2200, and a host attestation module 2300.

The host processor 2100 may control a general operation of the host device 2000. In some example embodiments, host processor 2300 may execute an application or a virtual machine.

The host DICE 2200 may generate a host compound device identifier (CDI) based on unique information of the host device 2000. In some example embodiments, unique information of the host device 2000 may include information on a serial number of the host device 2000 and codes executed when the host device 2000 is initially booted.

In some example embodiments, the host CDI is information for distinguishing the host device 2000 from other devices, and may be a host identification (ID) for identifying that the device is the host device 2000.

The host attestation module 2300 may generate a host public key and a host private key based on the host CDI. The host attestation module 2300 may generate a host signature by using the host private key. The host attestation module 2300 may decrypt the host signature by using the host public key.

In some example embodiments, the host attestation module 2300 may generate a host signature by signing information received from the storage device 1000 as the host private key, and may generate a device certificate including the host signature. The information received from the storage device 1000 may include a device public key generated by the storage device 1000.

In some example embodiments, the host attestation module 2300 may verify reliability of the storage device 1000 based on a result of verifying the device certificate by using the host public key. For example, the host attestation module 2300 may verify whether the storage device 1000 is forged and falsified based on a result of comparing information generated by decrypting the host signature included in the device certificate with the host public key and information included in the device certificate.

In some example embodiments, the host attestation module 2300 may generate a host signature by signing information that relates to the application executed by the host processor 2100 with the host private key, and may generate an application certificate including the host signature. The information relating to the application may include an application public key.

In some example embodiments, the host attestation module 2300 may verify reliability of the application executed by the host processor 2100 based on a result of verifying the application certificate by using the host public key. For example, the host attestation module 2300 may verify whether the application executed by the host device 2000 is forged and falsified based on a result of comparing information generated by decrypting the host signature included in the application certificate with the host public key and information included in the application certificate.

The host attestation module 2300 may, when reliability of the application is verified, transmit or send a request of registering an application for allocating a storage region to be used by the application to the storage device 1000.

The storage device 1000 may include a nonvolatile memory device 1100, a storage controller 1200, and a volatile memory device 1300.

The nonvolatile memory device 1100 may store data. The nonvolatile memory device 1100 may be operated in response to control by the storage controller 1200. In some example embodiments, the nonvolatile memory device 1100 may be a NAND flash memory.

The nonvolatile memory device 1100 may receive a command and an address from the storage controller 1200, and may perform an operation instructed by the command, on a region selected by the address. The nonvolatile memory device 1100 may perform a program operation (or a write operation) for storing data in the region selected by the address, a read operation for reading data, or an erase operation for deleting data.

The storage controller 1200 may control a general operation of the storage device 1000.

In some example embodiments, the storage controller 1200 may execute firmware when a power voltage is supplied to the storage device 1000. The firmware may include a host interface layer for controlling communication with the host device 2000, a flash converting layer for controlling communication between the host device 2000 and the nonvolatile memory device 1100, and a memory interface layer for controlling communication with the nonvolatile memory device 1100.

In some example embodiments, the storage controller 1200 may control the nonvolatile memory device 1100 to perform the write operation, the read operation, or the erase operation according to a request by the host device 2000. The storage controller 1200 may provide, transmit, or send a write command, an address, and data to the nonvolatile memory device 1100 during the write operation. The storage controller 1200 may provide, transmit, or send a read command and an address to the nonvolatile memory device 1100 during the read operation. The storage controller 1200 may provide, transmit, or send an erase command and an address to the nonvolatile memory device 1100 during the erase operation.

In some example embodiments, the storage controller 1200 may include a device DICE (Device Identifier Composition Engine) 1210 and a device attestation module 1220.

The device DICE 1210 may generate a device CDI (Compound Device Identifier) based on unique information of the storage device 1000. In some example embodiments, the unique information of the storage device 1000 may include information on a serial number of the storage device 1000 and a read-only memory (ROM) code executed when the storage device 1000 is initially booted.

In some example embodiments, the device CDI is information for distinguishing the storage device 1000 from other devices, and it may be a storage device ID for identifying that the device is the storage device 1000.

The device attestation module 1220 may generate a device public key and a device private key based on the device CDI. The device attestation module 1220 may generate a device signature by using the device private key. The device attestation module 1220 decrypts the device signature by using the device public key.

In some example embodiments, the device attestation module 1220 may generate a device signature by signing information received from the host device 2000 with the device private key, and may generate a host certificate including the device signature. The information received from the host device 2000 may include a host public key.

In some example embodiments, the device attestation module 1220 may verify reliability of the host device 2000 based on a result of verifying the host certificate by using the device public key. For example, the device attestation module 1220 may verify whether the host device 2000 is forged and falsified based on a result of comparing information generated by decrypting the device signature included in the host certificate with the device public key and information included in the device certificate.

In some example embodiments, the device attestation module 1220 may verify reliability of the application executed by the host processor 2100 based on a result of verifying the application certificate by using the host public key included in the host certificate. For example, the device attestation module 1220 may verify whether the application executed by the host processor 2100 is forged and falsified based on a result of comparing information generated by decrypting the host signature included in the application certificate with the host public key and information included in the application certificate.

In some example embodiments, the device attestation module 1220 may register the application based on a result of verifying the host certificate and the application certificate, and may generate a token used for the application to access the storage device 1000.

In some example embodiments, the device attestation module 1220 may transmit, provide, or send a request of attesting an application to the host attestation module 2300 when receiving a request of accessing data from the host processor 2100 executing the application. The host attestation module 2300 may generate application attestation data for attesting reliability of the application in response to the request of attesting an application, and may transmit, provide, or send the application attestation data to the device attestation module 1220.

In some example embodiments, the device attestation module 1220 may generate a shared key used in data communication between the application and the storage device 1000 based on a result of verifying the application attestation data. The host processor 2100 executing the application may access the data stored in the storage device 1000 by using the shared key, or may provide/send data.

The volatile memory device 1300 may temporarily store the data provided by the host device 2000, or may temporarily store the data read from the nonvolatile memory device 1100. In some example embodiments, the volatile memory device 1300 may be a dynamic random access memory (DRAM) or a static random access memory (SRAM). In some example embodiments, the volatile memory device 1300 may be disposed (e.g., located) inside/outside the storage controller 1200.

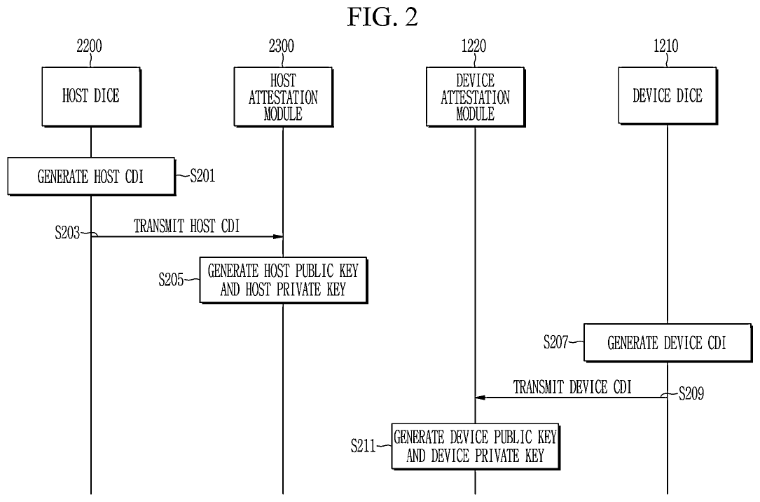

FIG. 2 shows an electronic system for generating a public key and a private key according to some example embodiments.

Referring to FIG. 2, in operation S201, the host DICE 2200 may generate a host CDI based on unique information of the host device 2000.

In operation S203, the host DICE 2200 may transmit the host CDI to the host attestation module 2300.

In operation S205, the host attestation module 2300 may generate a host public key and a host private key based on the host CDI. The host private key may be used in generating the host signature. The host public key may be used in decrypting the host signature.

In operation S207, the device DICE 1210 may generate a device CDI based on unique information of the storage device 1000.

In operation S209, the device DICE 1210 may transmit or send the device CDI to the device attestation module 1220.

In operation S211, the device attestation module 1220 may generate a device public key and a device private key based on the device CDI. The device private key may be used in generating the device signature. The device public key may be used in decrypting the device signature.

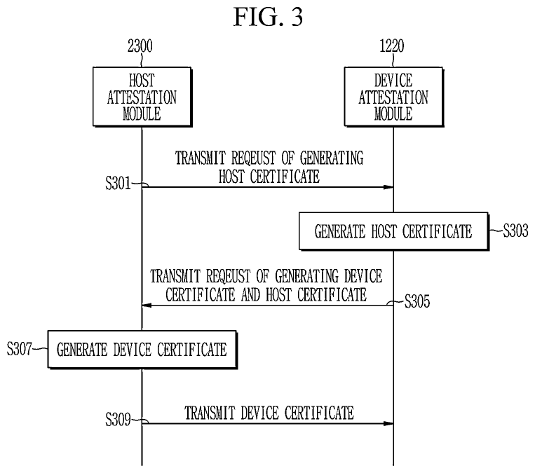

FIG. 3 shows an electronic system for generating a host certificate and a device certificate according to some example embodiments.

Referring to FIG. 3, in operation S301, the host attestation module 2300 may transmit or send a request of generating a host certificate to the device attestation module 1220. The request of generating a host certificate may include host information and a host public key.

In operation S303, the device attestation module 1220 may generate a host certificate in response to the request of generating a host certificate. For example, the device attestation module 1220 may generate a first device signature generated by signing the host information and the host public key with the device private key, and may generate a host certificate including a first device signature, a host public key, and host information.

In operation S305, the device attestation module 1220 may transmit or send the host certificate and a request of generating a device certificate to the host attestation module 2300. The request of generating a device certificate may include a device public key and device information.

In operation S307, the host attestation module 2300 may receive the host certificate, and may generate a device certificate in response to the request of generating a device certificate. For example, the host attestation module 2300 may generate a first host signature by signing the device public key and the device information with the host private key, and may generate a host certificate including a first host signature, a host public key, and host information.

In operation S309, the host attestation module 2300 may transmit or send the device certificate to the device attestation module 1220.

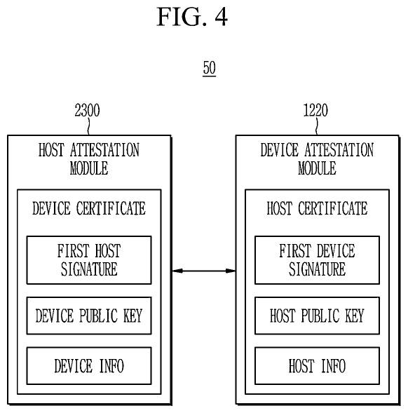

FIG. 4 shows a host certificate and a device certificate according to some example embodiments.

Referring to FIG. 4, the electronic system 50 may include a host attestation module 2300 and a device attestation module 1220. The host attestation module 2300 may be included in the host device 2000, and the device attestation module 1220 may be included in the storage device 1000.

In some example embodiments, the host attestation module 2300 may generate a host public key and a host private key based on the host CDI generated from the host DICE 2200.

The host attestation module 2300 may receive the request of generating a device certificate including a device public key and device information from the device attestation module 1220. In some example embodiments, the device information may include information on a country that made the storage device 1000, a manufacturer, a serial number of the storage device 1000, and a version of the storage device 1000.

The host attestation module 2300 may generate a first host signature by signing the device public key and the device information with the host private key in response to the request of generating a device certificate. In some example embodiments, the first host signature may be data generated by encrypting the device public key and device information with the host private key. In some example embodiments, the first host signature may be data generated by encrypting a hash value obtained by performing a hash operation on the device public key and device information with the host private key.

The host attestation module 2300 may generate a device certificate including a first host signature, a device public key, and device information in response to the request of generating a device certificate.

In some example embodiments, the device attestation module 1220 may generate a device public key and a device private key based on the device CDI generated from the device DICE 1210.

The device attestation module 1220 may receive the request of generating a host certificate including a host public key and host information from the host attestation module 2300. In some example embodiments, the host information may include information on a country that made the host device 2000, a manufacturer, a serial number of the host device 2000, and a version of the host device 2000.

The device attestation module 1220 may generate a first device signature by signing the host public key and host information with the device private key in response to the request of generating a host certificate.

In some example embodiments, the first device signature may be data generated by encrypting the host public key and host information with the device private key. In some example embodiments, the first device signature may be data generated by encrypting a hash value obtained by performing a hash operation on the host public key and host information with the device private key.

The device attestation module 1220 may generate a host certificate including a first device signature, a host public key, and host information in response to the request of generating a host certificate.

In some example embodiments, the host device 2000 including the host attestation module 2300 may generate a device certificate, and the storage device 1000 including the device attestation module 1220 may generate a host certificate. The host device 2000 may verify reliability of the storage device 1000 by using the device certificate, and the storage device 1000 may verify reliability of the host device 2000 by using the host certificate.

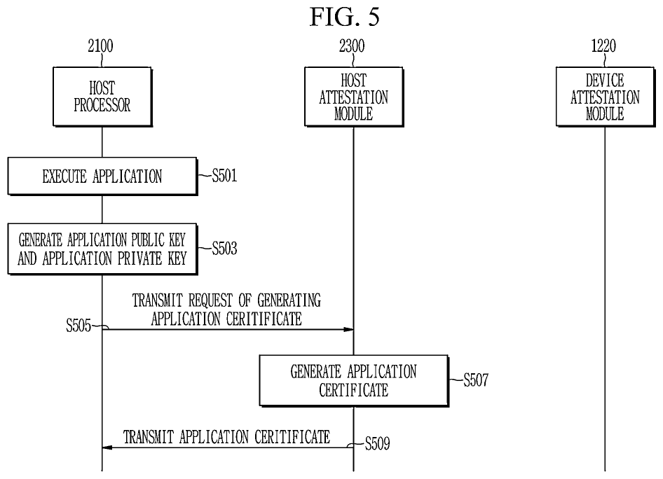

FIG. 5 shows an electronic system for generating an application certificate according to some example embodiments.

Referring to FIG. 5, in operation S501, the host processor 2100 may execute the application.

In operation S503, the host processor 2100 may generate an application public key and an application private key based on the application ID. In some example embodiments, the application ID may be data generated by using unique information of the application. For example, the application ID may be data generated by combining information on a generation date and a version of the application.

In operation S505, the host processor 2100 may transmit or send the request of generating an application certificate to the host attestation module 2300. The request of generating an application certificate may include an application public key and application information.

In operation S507, the host attestation module 2300 may generate a second host signature by signing the application public key and application information with the host private key in response to the request of generating an application certificate, may generate a first measurement value of the application, and may generate an application certificate including a second host signature, an application public key, a first measurement value, and application information.

In operation S509, the host attestation module 2300 may transmit or send the application certificate to the host processor 2100.

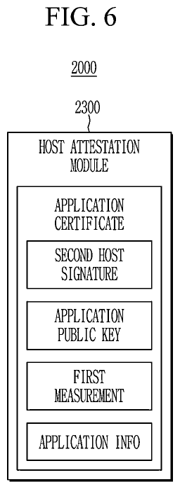

FIG. 6 shows an application certificate according to some example embodiments.

Referring to FIG. 6, the host device 2000 may include a host attestation module 2300. In some example embodiments, the host attestation module 2300 may receive the request of generating an application certificate including the application public key and application information from the host processor 2100. In some example embodiments, the application information may include information on a country that made the application, a company, and a version of the application.

The host attestation module 2300 may generate a second host signature by signing the application public key and application information with the host private key in response to the request of generating an application certificate. In some example embodiments, the second host signature may be data generated by encrypting the application public key and application information with the host private key. In some example embodiments, the second host signature may be data generated by encrypting a hash value obtained by performing a hash operation on the application public key and application information with the host private key.

The host attestation module 2300 may generate a first measurement value of the application in response to the request of generating an application certificate. In some example embodiments, the first measurement value may be data generated by the host attestation module 2300 by combining the application information. For example, the host attestation module 2300 may generate a first measurement value including the hash value obtained by performing a hash operation on the application information.

In some example embodiments, the first measurement value may be data generated by the host attestation module 2300 by combining the application information and salt. In some example embodiments, the salt may be data for indicating a value arbitrarily generated by the host attestation module 2300. For example, the host attestation module 2300 may generate a first measurement value including a hash value obtained by performing a hash operation on the application information and the salt.

The host attestation module 2300 may generate an application certificate including a second host signature, an application public key, a first measurement value, and application information in response to the request of generating an application certificate.

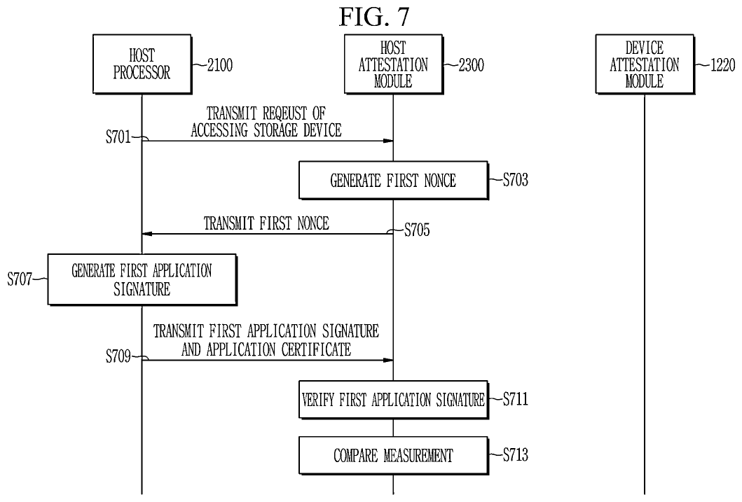

FIG. 7 shows an electronic system for verifying an application executed by a host processor according to some example embodiments.

Referring to FIG. 7, in operation S701, the host processor 2100 for executing applications may transmit or send the request of accessing a storage device for accessing the storage device 1000 to the host attestation module 2300.

In some example embodiments, the host attestation module 2300 may generate a first nonce and a second measurement value of the application in response to the request of accessing a storage device, and may verify reliability of the application executed by the host processor 2100 based on the first nonce and the second measurement value. In some example embodiments, the first nonce may be data arbitrarily generated by the host attestation module 2300 in response to the request of accessing a storage device.

For example, in operation S703, the host attestation module 2300 may generate a first nonce.

In operation S705, the host attestation module 2300 may transmit or send the first nonce to the host processor 2100.

In operation S707, the host processor 2100 may generate a first application signature by signing the first nonce with the application private key. In some example embodiments, the first application signature may be data generated by encrypting the first nonce with the application private key.

In operation S709, the host processor 2100 may transmit or send the first application signature and the application certificate to the host attestation module 2300.

In operation S711, the host attestation module 2300 may verify the first application signature. For example, the host attestation module 2300 may obtain a second nonce generated by decrypting the first application signature with the application public key included in the application certificate. The host attestation module 2300 may verify reliability of the application based on a result of comparing the first nonce and the second nonce.

In some example embodiments, the verification of the first application signature may fail when the first nonce and the second nonce are not the same. The host attestation module 2300 may discern that the application is forged and falsified when the verification of the first application signature fails. The host attestation module 2300 may transmit or send a response that the request of accessing a storage device failed to the host processor 2100 when the verification of the first application signature fails.

In some example embodiments, the host attestation module 2300 may generate a second measurement value of the application when the first nonce and the second nonce are the same. In some example embodiments, the second measurement value may be data generated by the host attestation module 2300 by combining the application information and the salt. For example, the host attestation module 2300 may generate a second measurement value including a hash value obtained by performing a hash operation on the application information and the salt in response to the request of accessing a storage device.

In operation S713, the host attestation module 2300 may verify reliability of the application based on a result of comparing the first measurement value and the second measurement value included in the application certificate.

In some example embodiments, the verification of the application may fail when the first measurement value and the second measurement value are not the same. The host attestation module 2300 may discern that the application is forged and falsified when the verification of the application fails. The host attestation module 2300 may transmit or send a response indicating that the request of accessing a storage device failed to the host processor 2100 when the verification of the application fails. In some example embodiments, the verification of the application may pass when the first measurement value and the second measurement value are the same. The host attestation module 2300 may discern that the application is not forged and falsified when the verification of the application passes.

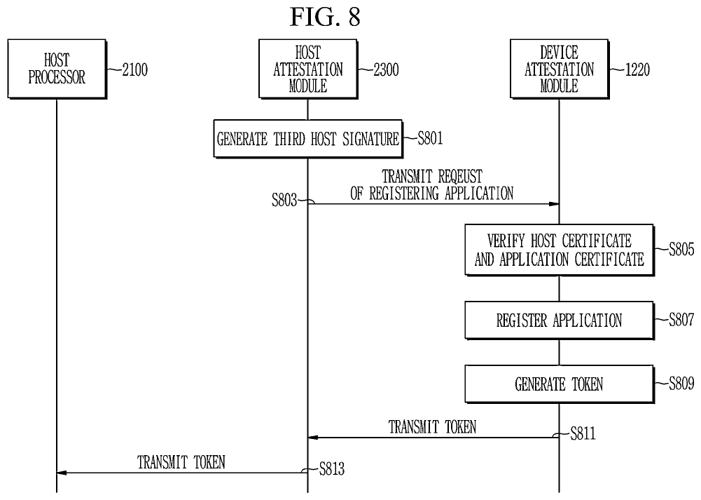

FIG. 8 shows an electronic system for registering information on an application based on a result of verifying an application according to some example embodiments.

Referring to FIG. 8, in operation S801, the host attestation module 2300 may verify reliability of the application based on the first nonce and the second measurement value of the application, and may generate a third host signature. For example, the host attestation module 2300 may generate the third host signature by signing the second measurement value of the application and application information with the host private key. In some example embodiments, the third host signature may be data generated by encrypting the second measurement value and application information with the host private key. In some example embodiments, the third host signature may be data generated by encrypting a hash value obtained by performing a hash operation on the second measurement value and application information with the host private key.

In operation S803, the host attestation module 2300 may transmit or send the request of registering an application including a third host signature, an application certificate, a second measurement value, and application information to the device attestation module 1220. The request of registering an application may be a request for registering the application executed by the host processor 2100 to the storage device 1000.

In operation S805, the device attestation module 1220 may verifying the host certificate and the application certificate in response to the request of registering an application.

In some example embodiments, the device attestation module 1220 may verify reliability of the host attestation module 2300 based on a result of comparing data obtained by decrypting the first device signature included in the host certificate with the device public key, the host public key included in the host certificate, and host information. In some example embodiments, the verification of the host certificate may fail when the hash value generated by decrypting the first device signature with the device public key and the hash value obtained by performing a hash operation on the host public key and host information are not the same. The device attestation module 1220 may discern that the host attestation module 2300 is forged and falsified when the verification of the host certificate fails. The device attestation module 1220 may transmit or send a response indicating that the request of registering an application failed to the host attestation module 2300 when the verification of the host certificate fails.

In some example embodiments, the verification of the host certificate may pass when the hash value generated by decrypting the first device signature with the device public key and the hash value obtained by performing a hash operation on the host public key and host information are the same.

In some example embodiments, the device attestation module 1220 may verify the application certificate when the verification of the host certificate passes. For example, the device attestation module 1220 may verify reliability of the application based on a result of comparing data generated by decrypting the second host signature included in the application certificate with the host public key, the application public key included in the application certificate, the first measurement value, and application information.

In some example embodiments, the device attestation module 1220 may fail the verification of the application certificate when the hash value generated by decrypting the second host signature with host public key, the application public key, the first measurement value, and the hash value obtained by performing a hash operation on the application information are not the same. The device attestation module 1220 may discern that the application executed by the host processor 2100 is forged and falsified when the verification of the application certificate fails. The device attestation module 1220 may transmit or send a response indicating that the request of registering an application failed to the host attestation module 2300 when the verification of the application certificate fails.

In some example embodiments, the verification of the application certificate may pass when the hash value generated by decrypting the second host signature with the host public key and the hash value obtained by performing a hash operation on the application public key, the first measurement value, and the application information are the same.

In some example embodiments, the device attestation module 1220 may verify the third host signature included in the request of registering an application. For example, the device attestation module 1220 may verify reliability of the host attestation module 2300 based on a result of comparing the data generated by decrypting the third host signature with the host public key, the second measurement value included in the request of registering an application, and application information.

In some example embodiments, the verification of the third host signature may fail when the hash value generated by decrypting the third host signature with the host public key and the hash value obtained by performing a hash operation on the second measurement value and application information are not the same. The device attestation module 1220 may discern that the host attestation module 2300 is forged and falsified when the verification of the host certificate fails. The device attestation module 1220 may transmit or send a response indicating that the request of registering an application failed to the host attestation module 2300 when the verification of the host certificate fails.

In some example embodiments, the verification of the third host signature may pass when the hash value generated by decrypting the third host signature with the host public key and the hash value obtained by performing a hash operation on the second measurement value and application information.

In operation S807, the device attestation module 1220 may register the application executed by the host processor 2300 when the verification of the host certificate and the application certificate passes. The device attestation module 1220 may store the second measurement value, the application information, and the application certificate included in the request of registering an application as register information of the application.

In operation S809, the device attestation module 1220 may register the application, and may generate a token to be used for the application to access the storage device. For example, the device attestation module 1220 may generate a second device signature by signing the application certificate and meta data relating to the application with the device private key, and may generate a token including the second device signature, the application certificate, and the meta data relating to the application.

In operation S811, the device attestation module 1220 may transmit or send the token to the host attestation module 2300.

In operation S813, the host attestation module 2300 may transmit or send the token to the host processor 2100. The host processor 2100 executing the application may access the storage device 1000 by using the token.

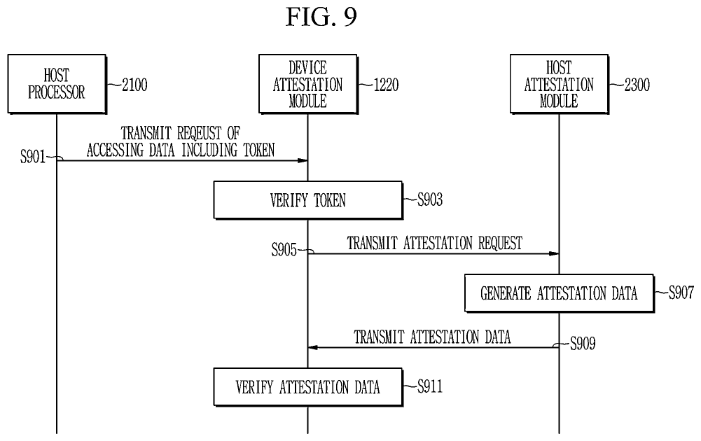

FIG. 9 shows an electronic system for requesting attestation of an application according to some example embodiments.

Referring to FIG. 9, in operation S901, the host processor 2100 may transmit or send a request of accessing data including a token to the device attestation module 1220. The request of accessing data may be a request for providing data to the storage device 1000 or accessing the data stored in the storage device 1000.

In operation S903, the device attestation module 1220 may verify the token. For example, the device attestation module 1220 may verify reliability of the application executed by the host processor 2100 based on a result of comparing the data generated by decrypting the second device signature included in the token with the device public key, and the application certificate and the meta data relating to the application included in the token.

In some example embodiments, the verification of the token may fail when the hash value generated by decrypting the second device signature with the device public key and the hash value obtained by performing a hash operation on the application certificate and the meta data relating to the application are not the same. The device attestation module 1220 may transmit or send a response indicating that the request of accessing data failed to the host processor 2100 when the verification of the token fails.

In some example embodiments, the verification of the token may pass when the hash value generated by decrypting the second device signature with the device public key and the hash value obtained by performing a hash operation on the application certificate and the meta data relating to the application are the same.

In operation S905, the device attestation module 1220 may transmit or send the request of attesting an application executed by the host processor 2100 to the host attestation module 2300 in response to the request of accessing data. In some example embodiments, the request of attesting an application may include an application ID for identifying the application executed by the host processor 2100.

In operation S907, the host attestation module 2300 may generate application attestation data used in attesting the application in response to the request of attesting an application. For example, the host attestation module 2300 may generate a third measurement value of the application in response to the request of attesting an application. The host attestation module 2300 may generate a fourth host signature by signing the third measurement value with the host private key. The fourth host signature may be data generated by encrypting the hash value obtained by performing a hash operation on the third measurement value with the host private key.

The host attestation module 2300 may generate application attestation data including a fourth host signature and a third measurement value.

In operation S909, the host attestation module 2300 may transmit or send the application attestation data to the device attestation module 1220.

In some example embodiments, the device attestation module 1220 may generate a shared key used in data communication with the host processor 2100 executing the application based on a result of verifying the application attestation data.

For example, in operation S911, the device attestation module 1220 may verify the application attestation data. The device attestation module 1220 may verify reliability of the application based on a result of comparing the second measurement value that corresponds to the application executed by the host processor 2100 and the third measurement value included in the application attestation data from among the measurement values stored as register information of the applications.

In some example embodiments, the verification of the application attestation data may fail when the second measurement value and the third measurement value are not the same. The device attestation module 1220 may discern that the application is forged and falsified when the verification of the application attestation data fails.

In some example embodiments, the verification of the application attestation data may pass when the second measurement value and the third measurement value are the same. The device attestation module 1220 may discern that the application is not forged and falsified when the verification of the application attestation data passes.

In some example embodiments, the device attestation module 1220 may verify the fourth host signature included in the application attestation data. The device attestation module 1220 may verify reliability of the host attestation module 2300 having generated the application attestation data based on a result of comparing the data generated by decrypting the fourth host signature with the host private key and the third measurement value included in the application attestation data.

In some example embodiments, the verification of the fourth host signature may fail when the hash value generated by decrypting the fourth host signature with the host private key and the hash value obtained by performing a hash operation on the third measurement value are not the same. The device attestation module 1220 may discern that the host attestation module 2300 is forged and falsified when the verification of the fourth host signature fails.

In some example embodiments, the verification of the fourth host signature may pass when the hash value generated by decrypting the fourth host signature with the host private key and the hash value obtained by performing a hash operation on the third measurement value are the same. The device attestation module 1220 may discern that the host attestation module 2300 is not forged and falsified when the verification of the fourth host signature passes.

In some example embodiments, the storage device 1000 including the device attestation module 1220 may transmit or send the request of attesting an application to the host attestation module 2300 to prevent or reduce cases in which a malicious application having captured the token issued by the storage device requests data access. The storage device 1000 may verify reliability of the application based on the application attestation data received according to the request of attesting an application, and may prevent or reduce occurrences of the malicious applications having captured the token from acquiring the data stored in the storage device 1000.

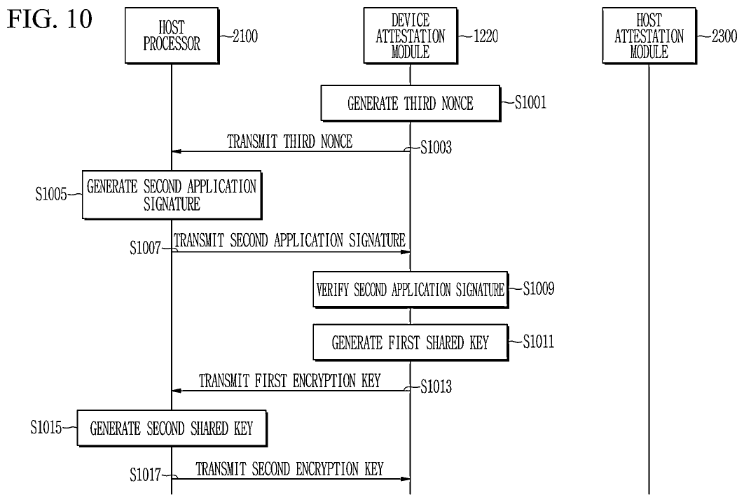

FIG. 10 shows an electronic system for generating a shared key based on a result of verifying application attestation data according to some example embodiments.

Referring to FIG. 10, in operation S1001, the device attestation module 1220 may generate a third nonce when the verification of the application attestation data passes. The third nonce may be data indicating a value arbitrarily generated by the device attestation module 1220.

In operation S1003, the device attestation module 1220 may transmit or send the third nonce to the host processor 2100.

In operation S1005, the host processor 2100 executing the application may generate a second application signature by signing the third nonce with the application private key. In some example embodiments, the second application signature may be data generated by encrypting the third nonce with the application private key.

In operation S1007, the host processor 2100 may transmit or send the second application signature to the device attestation module 1220.

In operation S1009, the device attestation module 1220 may verify the second application signature. For example, the device attestation module 1220 may obtain a fourth nonce by decrypting the second application signature with the application public key included in the application certificate. The device attestation module 1220 may verify reliability of the application based on a result of comparing the third nonce and the fourth nonce.

In some example embodiments, the verification of the second application signature may fail when the third nonce and the fourth nonce are not the same. The device attestation module 1220 may discern that the application is forged and falsified when the verification of the second application signature fails.

In some example embodiments, the verification of the second application signature may pass when the third nonce and the fourth nonce are the same. The device attestation module 1220 may discern that the application is not forged and falsified when the verification of the second application signature passes.

In some example embodiments, the device attestation module 1220 may generate a shared key used in data communication with the host processor 2100 executing the application when the verification of the application attestation data and the second application signature passes.

For example, in operation S1011, the device attestation module 1220 may generate a first shared key.

In operation S1013, the device attestation module 1220 may generate a first encryption key by encrypting the first shared key with the application public key, and may transmit or send the first encryption key to the host processor 2100.

In operation S1015, the host processor 2100 may obtain a first shared key generated by decrypting the first encryption key with the application private key and generate a second shared key. The first shared key may be used in transmitting or sending the data generated by the application executed by the host processor 2100 to the storage device 1000. The host processor 2100 may generate a second shared key.

In operation S1017, the host processor 2100 may generate a second encryption key by encrypting the second shared key with the device public key, and may transmit or send the second encryption key to the device attestation module 1220. The device attestation module 1220 may obtain a second shared key by decrypting the second encryption key with the device private key. The first shared key may be used in transmitting the data stored in the storage device 1000 to the host processor 2100 executing the application.

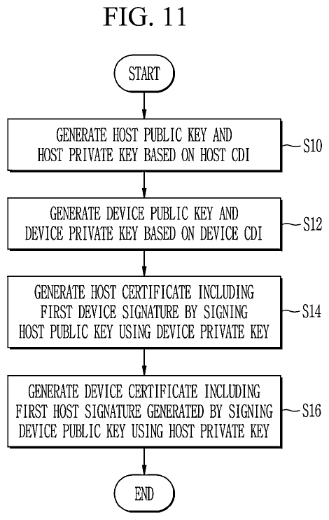

FIG. 11 shows an electronic system for generating a host certificate and a device certificate according to some example embodiments.

Referring to FIG. 11, in operation S10, the host attestation module 2300 included in the electronic system 50 may generate a host public key and a host private key based on the host CDI. The host CDI may be generated based on unique information of the host device 2000.

In operation S12, the device attestation module 1220 included in the electronic system 50 may generate a device public key and a device private key based on the device CDI. The device CDI may be generated based on unique information of the storage device 1000.

In operation S14, the device attestation module 1220 may generate a host certificate including the first device signature generated by signing the host public key by using the device private key. The device attestation module 1220 may transmit or send the host certificate to the host attestation module 2300. In some example embodiments, the first device signature may be data generated by encrypting the host public key with the device private key. The first device signature may be decrypted by the device public key.

In operation S16, the host attestation module 2300 may generate a device certificate including the first host signature generated by signing the device public key by using the host private key. The host attestation module 2300 may transmit the device certificate to the device attestation module 1220. In an embodiment, the first host signature may be data generated by encrypting the device public key with the host private key. The first host signature may be decrypted by the host public key.

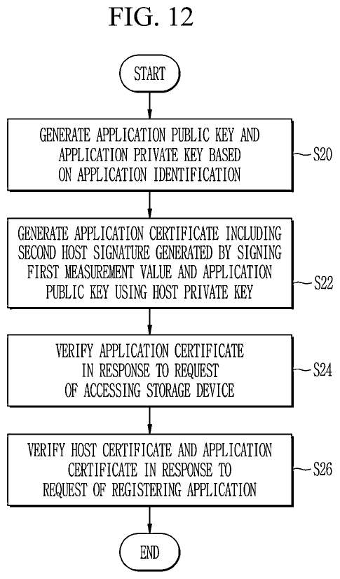

FIG. 12 shows an electronic system for verifying an application according to some example embodiments.

Referring to FIG. 12, in operation S20, the host processor 2100 included in the electronic system 50 may generate an application public key and an application private key based on the application ID. The application ID may be data generated by using unique information of the application. The host processor 2100 may transmit or send the application public key to the host attestation module 2300 included in the electronic system 50.

In operation S22, the host attestation module 2300 may generate an application certificate including the second host signature generated by signing the first measurement value and the application public key by using the host private key. In an embodiment, the second host signature may be data generated by encrypting the first measurement value and the application public key with the host private key. The second host signature may be decrypted by the host public key.

In operation S24, the host attestation module 2300 may verify the application certificate in response to the request of accessing a storage device received from the host processor 2300 executing the application.

In some example embodiments, the host attestation module 2300 may generate a second measurement value of the application, and may verify reliability of the application based on a result of comparing the first measurement value and the second measurement value included in the application certificate. In some example embodiments, the host attestation module 2300 may transmit or send the request of registering an application for registering the application to the storage device 1000 to the device attestation module 1220 included in the electronic system 50 when the verification of the application passes.

In operation S26, the device attestation module 1220 may verify the host certificate and the application certificate in response to the request of registering an application.

In some example embodiments, the device attestation module 1220 may verify reliability of the host attestation module 2300 based on a result of comparing the data generated by decrypting the first device signature included in the host certificate with the device public key and the hash value obtained by performing a hash operation on the host public key included in the host certificate. The device attestation module 1220 may verify reliability of the application based on a result of comparing the data generated by decrypting the second host signature included in the application certificate with the host public key included in the host certificate and the hash value obtained by performing a hash operation on the first measurement value included in the application certificate.

In some example embodiments, the device attestation module 1220 may register the application when the verification of the host certificate and the application certificate passes.

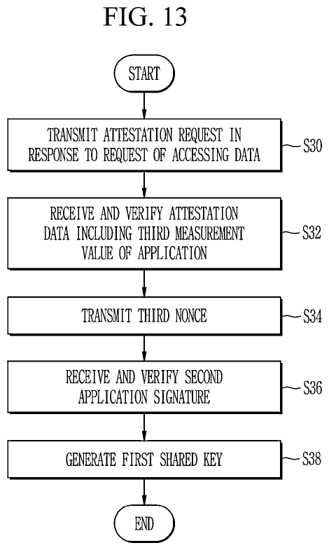

FIG. 13 shows a flowchart on an electronic system for requesting attestation of an application according to some example embodiments.

Referring to FIG. 13, in operation S30, the storage device 1000 included in the electronic system 50 may transmit or send the request of attesting an application to the host attestation module 2300 in response to the request of accessing data received from the host processor 2100 executing the application. The request of attesting an application may be a signal for requesting data for verifying reliability of the application.

In operation S32, the storage device 1000 may receive application attestation data including the third measurement value of the application, and may verify the application attestation data. The storage device 1000 may verify reliability of the application based on a result of comparing the second measurement value that corresponds to the application executed by the host processor 2100 and the third measurement value included in the application attestation data from among the measurement values of the registered applications.

In operation S34, the storage device 1000 may transmit or send the third nonce to the host processor 2100 when the verification of the application attestation data passes.

In operation S36, the storage device 1000 may receive the second application signature from the host processor 2100, and may verify the second application signature. The second application signature may be data generated by encrypting the third nonce with the application private key. In some example embodiments, the storage device 1000 may obtain a fourth nonce by decrypting the second application signature with the application public key included in the application certificate, and may verify reliability of the application based on a result of comparing the third nonce and the fourth nonce.

In operation S38, the storage device 1000 may generate a first shared key when the verification of the application attestation data and the second application signature passes. The first shared key may be used in the data communication with the host processor 2100.

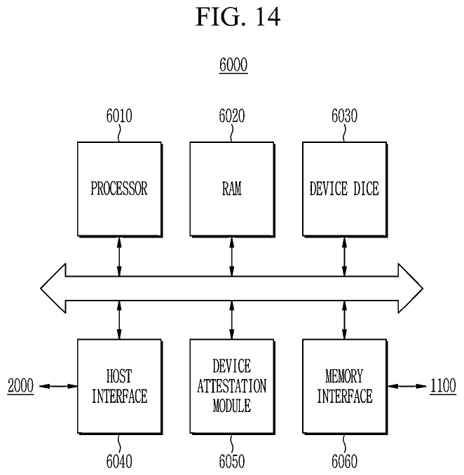

FIG. 14 shows a configuration of a storage controller according to some example embodiments.

Referring to FIG. 14, the storage controller 6000 may include a processor 6010, a RAM 6020, a device DICE 6030, a host interface 6040, a device attestation module 6050, and a memory interface 6060.

The processor 6010 may control a general operation of the storage controller 6000. The processor 6010 may control an operation of the storage controller 6000 to store the data requested from the host device 2000 in the nonvolatile memory device 1100.

The RAM 6020 may be used as a buffer memory, a cache memory, and an operation memory of the storage controller 6000. In some example embodiments, the RAM 6020 may temporarily store the host certificate, the device certificate, and the application certificate.

The device DICE 6030 may generate a device CDI based on unique information of the storage device 1000. The device CDI is information for distinguishing the storage device 1000 from other devices, and it may be a storage device ID for identifying that the device is the storage device 1000.

The storage controller 6000 may communicate with the host device 2000 through the host interface 6040. The storage controller 6000 may receive the data through the host interface 6040. In some example embodiments, the host interface 6040 may receive the device certificate from the host device 2000. The host interface 6040 may transmit or send the host certificate to the host device 2000.

The device attestation module 6050 may generate a device public key and a device private key based on the device CDI. The device attestation module 6050 may generate a first device signature by signing the host public key with the device private key, and may generate a host certificate including the first device signature. The host certificate may be provided or sent to the host device 2000 through the host interface 6040.

The storage controller 6000 may communicate with the nonvolatile memory device 1100 through the memory interface 6060. The storage controller 6000 may provide commands, addresses, data, etc., to the nonvolatile memory device 1100 through the memory interface 6060.

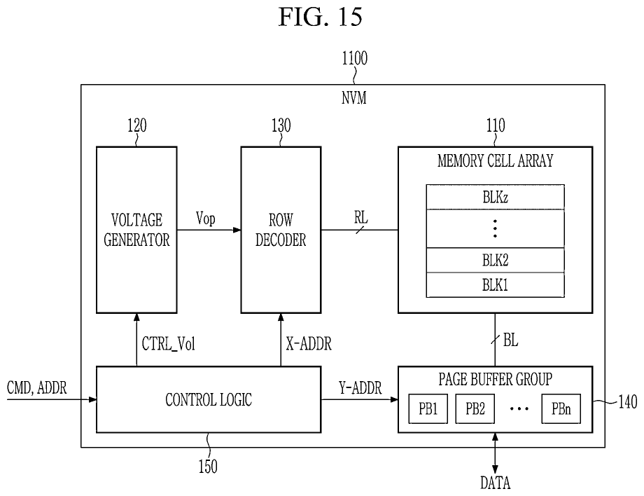

FIG. 15 shows a configuration of a nonvolatile memory device according to some example embodiments.

Referring to FIG. 15, the nonvolatile memory device 1100 may include a memory cell array 110, a voltage generator 120, a row decoder 130, a page buffer group 140, and a control logic 150.

The memory cell array 110 may include memory blocks BLK1 to BLKz. The memory blocks BLK1 to BLKz may be connected to the row decoder 130 through row lines RL. The memory blocks BLK1 to BLKz may be connected to the page buffer group 140 through bit lines BL. The respective memory blocks BLK1 to BLKz may include memory cells. In some example embodiments, the memory cells may be nonvolatile memory cells.

The voltage generator 120 may generate operating voltages Vop by using an external power voltage supplied to the nonvolatile memory device 1100. The voltage generator 120 may be operated in response to control by the control logic 150.

In some example embodiments, the voltage generator 120 may generate the operating voltages Vop used for the program operation, the read operation, and the erase operation. For example, the voltage generator 120 may generate an erase voltage, a program voltage, a pass voltage, and a read voltage. The operating voltages Vop may be supplied to the memory cell array 110 by the row decoder 130.

The row decoder 130 may be connected to the memory cell array 110 through the row lines RL. The row lines RL may include drain selecting lines, word lines, and source selecting lines.

The row decoder 130 may be operated in response to control by the control logic 150. The row decoder 130 may receive a row address X-ADDR from the control logic 150. In some example embodiments, the row decoder 130 may select at least one of the word lines based on the row address X-ADDR, and may apply the operating voltages Vop provided by the voltage generator 120 to the at least one word line.

In some example embodiments, the row decoder 130 may apply the program voltage to the selected one of the word lines and may apply the pass voltage that has a lower level than the program voltage to the unselected word lines during the program operation. The row decoder 130 may apply a verification voltage to the selected word line and may apply a verification pass voltage that has a higher level than the verification voltage to the unselected word lines during the program verification operation.

The row decoder 130 may apply the read voltage to the selected word line and may apply a read pass voltage that has a higher level than the read voltage to the unselected word lines during the read operation.

The page buffer group 140 may include page buffers PB1 to PBn. The page buffers PB1 to PBn may be connected to the memory cell array 110 through the bit lines BL. The page buffers PB1 to PBn may be operated in response to control by the control logic 150.

In some example embodiments, the page buffers PB1 to PBn may receive the data DATA from an outside. The page buffers PB1 to PBn may select at least one of the bit lines BL based on a column address Y-ADDR received from the control logic 150.

In some example embodiments, the page buffers PB1 to PBn may transmit or send the data received from the outside to the memory cells of the memory cell array 110 through the bit lines BL during the program operation. The memory cells may be programmed according to the received data. The page buffers PB1 to PBn may sense the data stored in the memory cells through the bit lines BL during the program verification operation.

The page buffers PB1 to PBn may sense the data stored in the memory cells through the bit lines BL and may store the sensed data in the page buffers PB1 to PBn during the read operation.

The control logic 150 may be connected to the voltage generator 120, the row decoder 130, and the page buffer group 140. The control logic 150 may control a general operation of the nonvolatile memory device 1100. The control logic 150 may be operated in response to the command CMD transmitted from the outside. The control logic 150 may generate various types of signals and may control the voltage generator 120, the row decoder 130, and the page buffer group 140 in response to the command CMD and the address ADDR.

As described herein, any devices, electronic devices, modules, units, and/or portions thereof according to any of the example embodiments, and/or any portions thereof may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, electronic devices, modules, units, and/or portions thereof according to any of the example embodiments.

Any of the memories described herein may be a nonvolatile memory, such as a flash memory, a phase-change random access memory (PRAM), a magneto-resistive RAM (MRAM), a resistive RAM (ReRAM), or a ferro-electric RAM (FRAM), or a volatile memory, such as a static RAM (SRAM), a dynamic RAM (DRAM), or a synchronous DRAM (SDRAM).

Any or all of the elements described with reference to the figures may communicate with any or all other elements described with reference to the figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be encoded in various formats, such as in an analog format and/or in a digital format.

While the inventive concepts have been described in connection with what is presently considered to be some example embodiments, it is to be understood that the present inventive concepts are not limited thereto, but, on the contrary, are intended to cover various modifications and equivalent arrangements included within the spirit and scope of the appended claims.

What is claimed is:

1. An electronic system, comprising:
a storage device configured to generate a device public key and a device private key based on a device compound device identifier (CDI) generated from a device DICE (Device Identifier Composition Engine), generate a host certificate including a first device signature generated by signing a host public key with the device private key in response to receiving a request of generating the host certificate including the host public key, and send a request of generating a device certificate including the host certificate and the device public key; and
a host device configured to generate the host public key and a host private key based on a host CDI generated by a host DICE, generate the device certificate including a first host signature generated by signing the device public key with the host private key in response to the request of generating the device certificate, and send the device certificate to the storage device.

2. The electronic system of claim 1, wherein
the host device includes:
a host processor configured to execute an application, generate an application public key and an application private key based on an application ID, and send a request of generating an application certificate including the application public key; and
a host attestation module configured to generate a first measurement value of the application in response to the request of generating the application certificate, generate a second host signature by signing the first measurement value with the host private key, and generate the application certificate including the first measurement value, the application public key, and the second host signature.

3. The electronic system of claim 2, wherein
the host attestation module is configured to generate a first nonce and a second measurement value of the application in response to receiving a request of accessing the storage device from the host processor, and verify the application executed by the host processor based on the first nonce and the second measurement value.

4. The electronic system of claim 3, wherein
when verifying the application,
the host processor is configured to send an application signature generated by signing the first nonce with the application private key to the host attestation module, and
the host attestation module is configured to obtain a second nonce generated by decrypting the application signature with the application public key, and verify the application based on the first nonce and the second nonce.

5. The electronic system of claim 3, wherein
when verifying the application,
the host attestation module is configured to verify the application based on the second measurement value and the first measurement value included in the application certificate.

6. The electronic system of claim 3, wherein
the host attestation module is configured to send a request of registering the application including a third host signature generated by signing the second measurement value with the host private key, the second measurement value, and the application certificate to the storage device based on a result of verifying the application.

7. The electronic system of claim 6, wherein
the storage device includes a device attestation module configured to register information of the application including the second measurement value based on a result of verifying the second host signature and the third host signature included in the application certificate with the host public key in response to the request of registering the application.

8. The electronic system of claim 7, wherein
the device attestation module is configured to send a token including a second device signature generated by signing the application certificate with the device private key and the application certificate to the host processor.

9. The electronic system of claim 2, wherein
the storage device is configured to send a request of attesting an application to the host attestation module in response to a request of accessing data received from the host processor.

10. The electronic system of claim 9, wherein
the host attestation module is configured to generate a third measurement value of the application in response to the request of attesting the application, and send application attestation data including the third measurement value to the storage device.

11. The electronic system of claim 10, wherein
the storage device is configured to generate a shared key for data communication with the application based on a second measurement value corresponding to the application and the third measurement value included in the application attestation data from among measurement values of registered applications.

12. A storage device, comprising:
a nonvolatile memory device configured to store data; and
a storage controller configured to
receive a request of accessing data from a host processor executing an application of a host device, the request requesting data,
send a request of attesting the application to a host attestation module of the host device, the request of attesting the application requesting attestation of the application, and
send the data to the host processor based on a result of verifying application attestation data received from the host attestation module.

13. The storage device of claim 12, wherein
the storage controller is configured to verify the host attestation module based on a result of decrypting a host signature included in the application attestation data with a host public key.

14. The storage device of claim 13, wherein
the storage controller is configured to generate a shared key based on a first measurement value corresponding to the application and a second measurement value included in the application attestation data from among measurement values of registered applications.

15. The storage device of claim 14, wherein
the storage controller is configured to send an encryption key generated by encrypting the shared key with an application public key to the host processor.

16. An electronic system, comprising:
a host processor;
a host attestation module; and
a storage device,
the host processor configured to execute an application, generate an application public key and an application private key based on an application ID, and send a request of accessing the storage device;
the host attestation module configured to generate a host public key and a host private key based on a host CDI (Compound Device Identifier), generate an application certificate by using the host private key, and send a request of registering the application based on a result of verifying the application certificate in response to the request of accessing the storage device; and
the storage device configured to generate a device public key and a device private key based on a device CDI, generate a host certificate by using the device private key, and register information of the application based on a result of verifying the host certificate and the application certificate in response to the request of registering the application.

17. The electronic system of claim 16, wherein
the host attestation module is configured to generate a first nonce in response to the request of accessing the storage device, receive an application signature generated by signing the first nonce with the application private key from the host processor, and compare a second nonce generated by decrypting the application signature with the application public key and the first nonce.

18. The electronic system of claim 16, wherein
the application certificate includes a first measurement value of the application, and
the host attestation module is configured to generate a second measurement value of the application in response to the request of accessing the storage device, and send the request of registering the application based on the first measurement value and the second measurement value included in the application certificate.

19. The electronic system of claim 16, wherein
the storage device is configured to decrypt a device signature included in the host certificate with the device public key in response to the request of registering the application, and register information of the application based on a result of decrypting a host signature included in the application certificate with the host public key.

20. The electronic system of claim 19, wherein
the storage device is configured to generate a token by using the device private key, and
the host processor is configured to access the storage device by using the token.
